(19) United States
(12) Patent Application Publication
(10) Pub. No.: US 2013/0327991 A1
(43) Pub. Date: Dec. 12, 2013

(54) APPARATUS, SYSTEM, AND METHOD FOR INHIBITING CORROSION IN A WASTE TANK

(71) Applicant: Harris Research, Inc., Logan, UT (US)

(72) Inventors: Edward E. Durrant, Paradise, UT (US); Dale S. Jensen, Smithfield, UT (US); Roger C. Andersen, Logan, UT (US)

(21) Appl. No.: 13/849,378

(22) Filed: Mar. 22, 2013

Related U.S. Application Data
(60) Provisional application No. 61/614,361, filed on Mar. 22, 2012.

(51) Int. Cl. C09K 15/02

(52) U.S. Cl. CPC C09K 15/02
USPC 252/387

(57) ABSTRACT

The present disclosure relates to an anti-corrosion substance that includes an anti-corrosion agent and a carrier material. The carrier material is at least minimally soluble in aqueous solutions. An anti-corrosion apparatus is also disclosed, the apparatus including an anti-corrosion agent and a carrier configured to controllably exude the contained anti-corrosion agent. Also disclosed is a method for producing a block of anti-corrosion substance, which includes selecting an anti-corrosion agent, selecting a carrier material, combining the anti-corrosion agent with the carrier material, and forming the anti-corrosion substance from the combination of the anti-corrosion agent and the carrier material.

### CROSS-REFERENCES TO RELATED APPLICATIONS

This application claims the benefit of U.S. Provisional Patent Application No. 61/614,361, entitled “Apparatus, System, and Method for Inhibiting Corrosion in a Waste Tank” and filed on Mar. 22, 2012 for Edward E. Durrant, et al., which is incorporated herein by reference.

### FIELD

This disclosure relates to corrosion inhibitors and more specifically relates to reducing corrosion in cleaning systems.

### BACKGROUND

In the cleaning industry, cleaning compounds, such as soaps, detergents, and surfactants, are often applied to dirty surfaces to extract dirt, oil, stains, bacteria, and other contaminants. Generally, such cleaning compounds are effective because their chemical structures include both polar (hydrophilic) and non-polar (hydrophobic) components. Therefore, cleaning compounds can be combined with a polar solvent, such as water, and are capable of dissolving and extracting non-polar solutes, such as oil, grease, dirt, and other contaminants. Once the contaminants have been extracted from the textile, the solution, now holding the suspended contaminants, can then be lifted from the textile and expelled, thus leaving behind a clean surface.

In conventional cleaning systems, the expelled cleaning solution, which contains the suspended contaminants, is often pumped or suctioned into a waste tank for temporary storage until the tank is emptied and the used cleaning solution is disposed of. These waste tanks are often constructed of some type of metal, for example, and are susceptible to electrochemical oxidation (i.e., corrosion). Although corrosion occurs naturally, the rate of corrosion can increase when metals are exposed to various chemicals and solutions. For example, in the present context, soaps and surfactants that are suctioned into waste tanks may promote corrosion and thereby shorten the useful life of a waste tank. Also, contaminants suspended in the cleaning solution, such as dirt and oil, can cause the rate of corrosion to increase.

In order to limit the rate and extent of corrosion, anti-corrosion agents have conventionally been added directly to the pre-application cleaning solution. Therefore, upon suctioning the used cleaning solution into the waste tank, the anti-corrosion agents are dispersed throughout the waste tank and can protect the surfaces of the waste tank against chemical breakdown. Although effective at reducing corrosion, this method involves treating the surface to be cleaned with the anti-corrosion agent, which can waste resources, potentially damage the surface to be cleaned, and may cause users that come into contact with the cleaned surface to be adversely exposed to any lingering anti-corrosion compounds.

Another conventional method for inhibiting corrosion involves the use of sacrificial anodes. Sacrificial anodes can be effective at reducing the rate of galvanic corrosion; however, if the corrosion is due to non-galvanic processes or the metal of the waste tank is more electrochemically active than the metal of the anode, the use of a sacrificial anode will be ineffective at inhibiting corrosion. In some applications, anti-corrosion agents are periodically added to the waste tank to prevent corrosion. Although this practice is effective at inhibiting corrosion, conventional anti-corrosion agents are not well suited for most cleaning systems. For example, if an anti-corrosion agent is added to the waste tank of a batch cleaning system, each time the contents of the waste tank are expelled, the dissolved anti-corrosion agent is expelled as well. Accordingly, for some systems, each time the contents of the tank are expelled, more anti-corrosion agent must be added to the waste tank for any subsequent batches. Also, in some continuous cleaning systems, where the waste tank is continuously emptied during the cleaning process, the user must repeatedly add more anti-corrosion agent during a single cleaning operation. Therefore, while the use of anti-corrosion agents in some cleaning systems may inhibit corrosion, because conventional anti-corrosion agents and systems require users to repeatedly monitor and add more anti-corrosion agent, the increased cost, inefficiency, and difficulty of utilizing such conventional anti-corrosion agents results in a bothersome, wasteful, and generally ineffective cleaning process.

### SUMMARY

From the foregoing discussion, it should be apparent that a need exists for an apparatus, system, and method to control the amount and dispersion of anti-corrosion agents into an aqueous solution. The present disclosure has been developed in response to the present state of the art, and in particular, in response to the problems and needs in the art that have not yet been fully solved by currently available cleaning systems and anti-corrosion agents. Accordingly, the present disclosure has been developed to provide an apparatus, system, and method for inhibiting corrosion in a waste tank that overcomes many or all of the above-discussed shortcomings in the art.

According to one exemplary embodiment, the present disclosure describes an anti-corrosion substance, which includes an anti-corrosion agent and a carrier material. The carrier material is at least minimally soluble in aqueous solutions. According to one embodiment, the carrier material may be an inorganic solid. In another embodiment, the anti-corrosion agent may include at least one type of silicate-based anti-corrosion compound. The mass ratio of anti-corrosion agent to carrier material may be between about 1:100 and 1:1. In another embodiment, the mass ratio may be between 1:20 and 1:5. In yet another embodiment, the mass ratio may be about 1:10.

Also included in the present disclosure is a description of one embodiment of a method for producing a block of anti-corrosion substance, which includes selecting an anti-corrosion agent, selecting a carrier material, combining the anti-corrosion agent with the carrier material, and forming the anti-corrosion substance from the combination of the anti-corrosion agent and the carrier material. The method for producing the anti-corrosion substance may further include preparing the carrier material by melting an organic acid to produce a molten organic acid material and combining the anti-corrosion agent with the molten organic acid material. Further, the method may include forming the anti-corrosion substance into a block by allowing the mixture of the anti-corrosion agent and the molten organic acid material to cool and solidify. In another embodiment for producing an anti-corrosion substance, the anti-corrosion agent may be combined with the carrier material by compression fusing the two together.

In another embodiment, an anti-corrosion apparatus includes an anti-corrosion agent and a carrier, where the carrier includes a means for restrictively and controllably exuding the anti-corrosion agent into an aqueous solution. The present disclosure further provides for a system for using an anti-corrosion apparatus, including an aqueous solution, a vessel containing the aqueous solution which is susceptible to corrosion, and an anti-corrosion apparatus located within the vessel and in at least partial fluid communication with the aqueous solution. The present disclosure also relates to an anti-corrosion system that includes a vessel containing an aqueous solution and an anti-corrosion substance.

Reference throughout this specification to features, advantages, or similar language does not imply that all of the features and advantages that may be realized with the present disclosure should be or are in any single embodiment of the present application. Rather, language referring to the features and advantages is understood to mean that a specific feature, advantage, or characteristic described in connection with an embodiment is included in at least one embodiment of the present disclosure. Thus, discussion of the features and advantages, and similar language, throughout this specification may, but do not necessarily, refer to the same embodiment.

Furthermore, the described features, advantages, and characteristics of the present application may be combined in any suitable manner in one or more embodiments. One skilled in the relevant art will recognize that the subject matter of the present application may be practiced without one or more of the specific features or advantages of a particular embodiment. In other instances, additional features and advantages may be recognized in certain embodiments that may not be present in all embodiments of the disclosure.

These features and advantages of the present disclosure will become more fully apparent from the following description and appended claims, or may be learned by the practice of the present application as set forth hereinafter.

### BRIEF DESCRIPTION OF THE DRAWINGS

In order that the advantages of the disclosure will be readily understood, a more particular description of the apparatus, systems and method briefly described above will be rendered by reference to specific embodiments that are illustrated in the appended drawings. Understanding that these drawings depict only typical embodiments of the disclosure and are not therefore to be considered to be limiting of its scope, the disclosure will be described and explained with additional specificity and detail through the use of the accompanying drawings, in which:

FIG. 1A is a cross-sectional view of one embodiment of a system for using an anti-corrosion substance, wherein the system includes an anti-corrosion substance attached to an inner wall of a vessel containing an aqueous solution;

FIG. 1B is a cross-sectional view of one embodiment of a system for using an anti-corrosion substance, wherein the system includes an anti-corrosion substance floating in an aqueous solution contained within a vessel;

FIG. 1C is a cross-sectional view of one embodiment of a system for using an anti-corrosion substance, wherein the system includes an anti-corrosion substance attached to an inner wall of an inlet line to a vessel containing an aqueous solution;

FIG. 2A is a cross-sectional view one embodiment of a system for using an anti-corrosion apparatus, wherein the system includes an anti-corrosion apparatus attached to an inner wall of a vessel containing an aqueous solution;

FIG. 2B is a cross-sectional view of one embodiment of a system for using an anti-corrosion apparatus, wherein the system includes an anti-corrosion apparatus floating in an aqueous solution contained within a vessel;

FIG. 2C is a cross-sectional view of one embodiment of a system for using an anti-corrosion apparatus, wherein the system includes an anti-corrosion apparatus attached to an inner wall of an inlet line to a vessel containing an aqueous solution;

FIG. 3 is schematic block diagram illustrating one embodiment of a method for producing an anti-corrosion substance; and

FIG. 4 is a schematic block diagram illustrating one embodiment of a method of using an anti-corrosion substance to inhibit corrosion in a waste tank.

### DETAILED DESCRIPTION

Conventional cleaning systems often involve applying cleaning solutions, such as soaps, surfactants, detergents, or other compounds, to a textile, floor, carpet, or other object to remove dirt, oil, stains, etc. Usually, after the cleaning solution has been applied, the solution is lifted from the object using a vacuum system. The used cleaning solution is then discharged into a waste tank.

The chemicals and constituents of the used cleaning solution interact with the surfaces of the waste tank and often promote corrosion. Because corrosion in the waste tank may produce undesirable effects (e.g., inconvenience, property damage, and equipment damage), conventional systems often use an anti-corrosion compound to inhibit corrosion. However, these conventional anti-corrosion compounds fail to effectively and efficiently inhibit corrosion without constant and repeated user monitoring and maintenance. The user has to repeatedly add more anti-corrosion compounds to the waste tank. This is true of both “open” cleaning systems and “batch” cleaning systems. An open system can be defined as a system where an aqueous solution flows both into and out of the waste tank simultaneously. In contrast, a multiple batch system is defined as a system where the vacuum is periodically turned off (once the used cleaning solution has substantially filled the waste tank) and the waste tank emptied before cleaning can resume. Generally, the present disclosure relates to improving conventional anti-corrosion compounds and anti-corrosion systems.

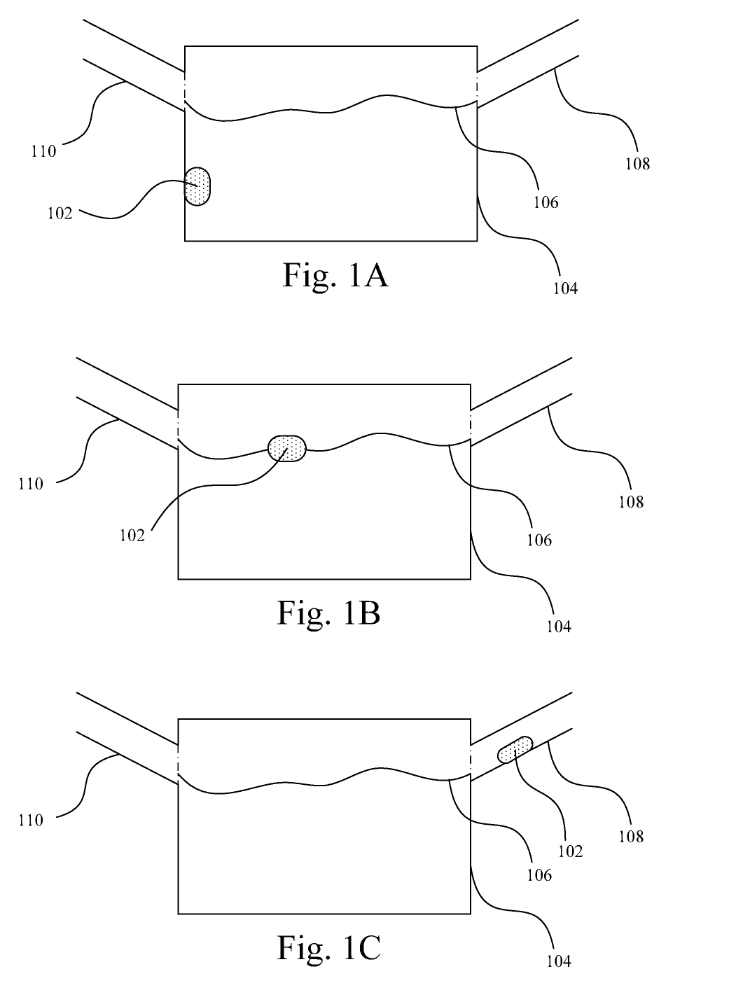

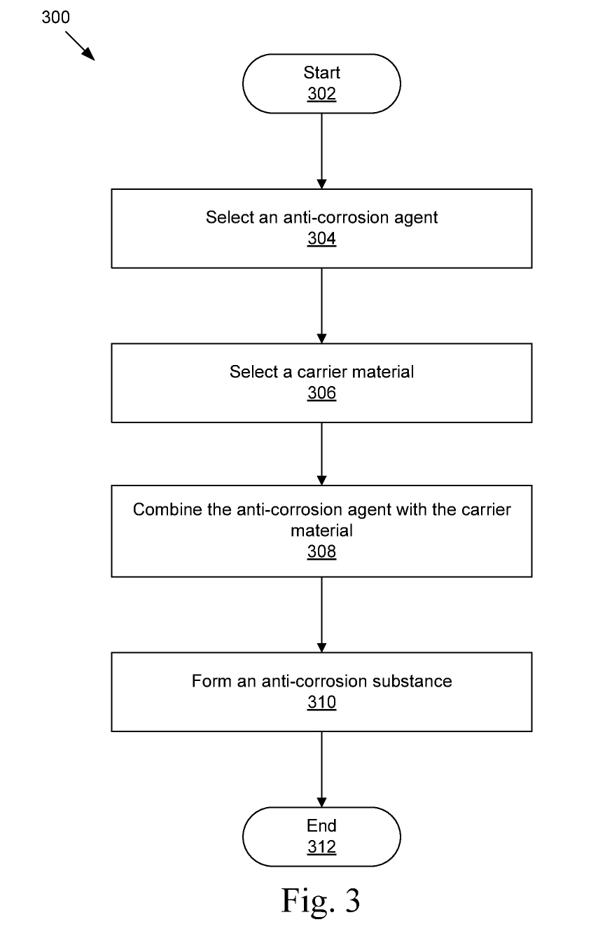

FIG. 1A is a cross-sectional view of one embodiment of an anti-corrosion system. The anti-corrosion system includes a block of an anti-corrosion substance 102. The anti-corrosion substance 102 includes a conglomeration or mixture of solid anti-corrosion agent and a carrier material. The anti-corrosion agent may be selected according to the characteristics of the cleaning system. For example, the type and quantity of surfactant used in the cleaning process, the type and quantity of contaminants suspended in the cleaning solution, and/or the properties of the aqueous solution generally may contribute to and promote the corrosion in the waste tank. In one embodiment, the anti-corrosion agent includes a single type of anti-corrosion compound selected for use in the anti-corrosion block 102. In another embodiment, the anti-corrosion agent includes multiple types of anti-corrosion compounds selected to inhibit various types of corrosion. Other characteristics of an aqueous solution that may affect the selection of an anti-corrosion agent include concentration of cleaning solution, pH, temperature, pressure, viscosity, solids content, volatiles content, and flow rate. Selection of the anti-corrosion agent will be described in greater detail below with reference to FIG. 3.

The carrier material may include one or more organic and/or inorganic solids. Preferably, the carrier material is at least minimally soluble in an aqueous solution at a relatively low temperature and is a solid at low to moderate temperatures. The carrier material is primarily selected according to its solubility in water. For example, magnesium sulfate has a water solubility of about 71 grams per liter and sodium carbonate has a water solubility of about 216 grams per liter. Therefore, if magnesium sulfate were selected as the carrier material, a comparatively lesser amount of anti-corrosion agent would be dispersed into the aqueous solution than if sodium carbonate were selected as the carrier material.

In one embodiment, the carrier material may include a single inorganic solid. In another embodiment, the carrier material may include multiple inorganic solids. According to one embodiment, when multiple carrier materials are used in a certain implementation, the user has greater control of the solubility of the final anti-corrosion substance 102 because the solubility of the anti-corrosion substance 102 is not limited to the solubility of a single inorganic solid. Instead, the solubility of the anti-corrosion substance 102 is the working average of multiple carrier materials. In this manner, the solubility of the block can be controlled and selected according to the characteristics of a particular application.

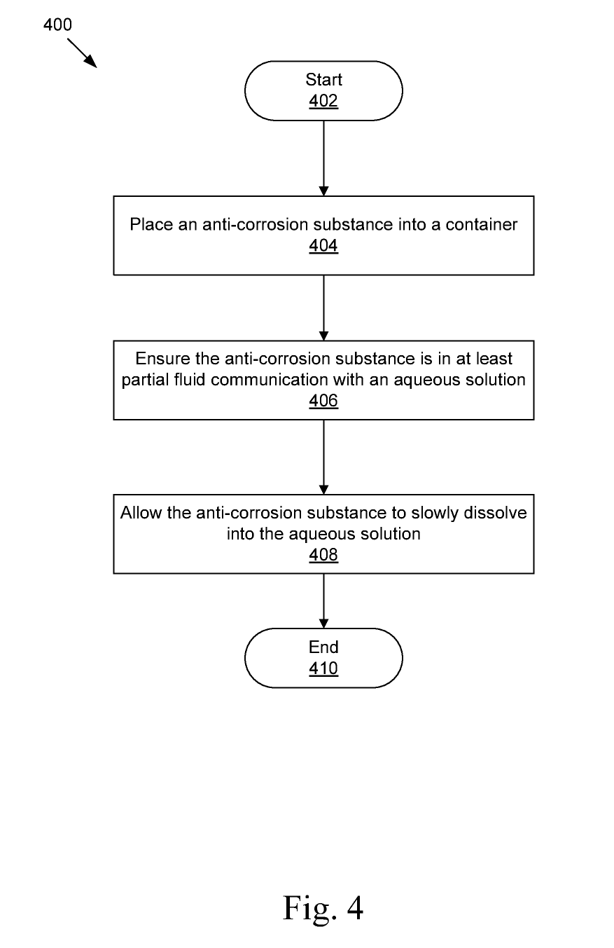

The melting temperature of the carrier material is a factor in both the fabrication and use of the anti-corrosion substance. Although described in greater detail below with reference to FIGS. 3 and 4, the melting temperature of the selected carrier material, in one embodiment, can be low enough so as to save on production energy costs. In another embodiment, the melting temperature can be high enough to prevent the anti-corrosion substance from melting in the aqueous solution in the waste tank. In some embodiments, the melting temperature of the carrier material is between about 50° C. and 1500° C. In some more specific implementations, the melting temperature of the carrier material is between about 100° C. and 500° C. Although the anti-corrosion block 102 is termed a block throughout the present disclosure, the anti-corrosion block need not be block-shaped (i.e., a flat side object), but can have any of various shapes and be any of various sizes.

As depicted in FIG. 1A, the anti-corrosion substance 102 may, in one embodiment, be attached to an inner wall of a vessel 104 containing an aqueous solution 106. In another embodiment, as depicted in FIG. 1B, the anti-corrosion substance 102 may be able to freely move about the vessel 104, either floating on the surface of the aqueous solution 106 or wholly or partially submerged in the aqueous solution 106. In yet another embodiment, as depicted in FIG. 1C, the anti-corrosion substance 102 may be attached to an inner wall of the inlet 108 of the vessel 104. It is contemplated that other positions and orientations of the anti-corrosion substance 102 within the vessel 104 fall within the scope of the disclosure, provided that such other positions and orientations allow the anti-corrosion substance 102 to be in at least partial fluid communication with the aqueous solution 106.

The vessel 104, in one embodiment, is a waste tank mounted in a truck or van for portable cleaning systems. In some embodiments, the vessel 104 includes a vacuum system where used cleaning solution is suctioned into the waste tank. In another embodiment, the vessel 104 has an exhaust outlet 110 where air and/or cleaning solution may be expelled. In another embodiment, the vessel 104 may be a small container within a household sized shampooing vacuum. The vessel 104 may be constructed of a metal, plastic, or polymer material. Accordingly, the anti-corrosion agent may be selected according to the material that constitutes the vessel 104 and/or the types of corrosion that are expected to occur with respect to the vessel material. It is contemplated that other containers, recognized by those of skill in the art, may fall within the scope of the present disclosure.

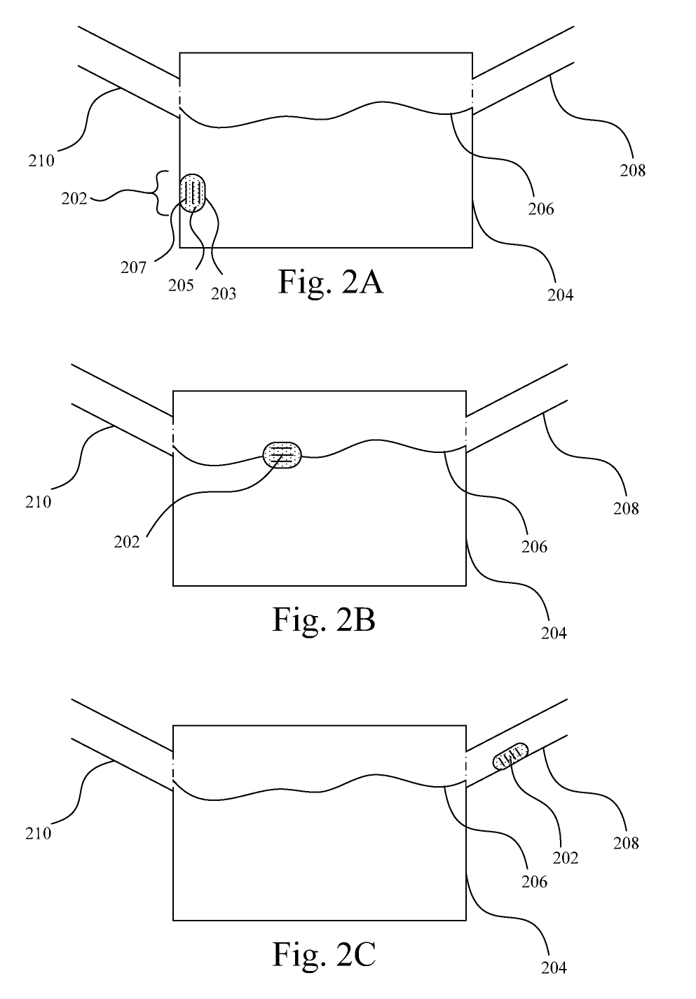

FIG. 2A is a cross-sectional view of one embodiment of a system for using an anti-corrosion apparatus 202. The anti-corrosion apparatus 202 is a carrier 203 that holds an anti-corrosion agent 205. The carrier 203 substantially encapsulates the anti-corrosion agent 205, but includes elements 207 for restrictively permitting (e.g., exuding) the anti-corrosion agent 205 to diffuse into an aqueous solution 206 stored within a vessel 204. Functionally, the carrier 203 is analogous to the carrier material described above with reference to FIGS. 1A, 1B, and 1C. In other words, the carrier 203 is selected to control the dissolution and dispersion of the anti-corrosion agent 205.

In one embodiment, for example, the carrier 203 includes a plastic container with slits 207 sized and shaped to allow the anti-corrosion agent 205 to slowly and predictively weep out of the container and into an aqueous solution 206, thereby limiting the rate of release and limiting the amount of anti-corrosion agent dispersed into the aqueous solution 206. In another embodiment, the carrier 203 may include a selectively permeable membrane 207 configured to control the rate and amount of the anti-corrosion agent 205 diffused into the aqueous solution 206. In another embodiment, the apparatus 202 may include a selectively controllable regulator 207, such as a solenoid valve or metered dispenser mechanism, which periodically releases a fraction of the stored anti-corrosion agent 205 into the aqueous solution 206. The anti-corrosion apparatus 202 can be made by selecting an anti-corrosion agent 205 and a carrier 203 and then loading the anti-corrosion agent into the carrier 203. It is contemplated that other carrier devices, recognized by those of ordinary level of skill in the art as capable of containing and restrictively discharging powdered and/or liquid anti-corrosion agents into an aqueous solution, fall within the scope of the present disclosure.

The apparatus 202 can be positioned within the container 204 in any number of configurations. As depicted in FIG. 2A, in one embodiment, the anti-corrosion apparatus 202 is attached to an inner wall of the vessel 204 storing the aqueous solution 206. In another embodiment, as depicted in FIG. 1B, the anti-corrosion apparatus 202 is not secured to any portion of the vessel 204, and is freely movable within the vessel 204. In such an embodiment, the apparatus 202 can be configured to float on the surface of the aqueous solution 206, or be wholly or partially submerged in the aqueous solution 206. In yet another embodiment, as depicted in FIG. 2C, the anti-corrosion apparatus 202 may be attached to an inlet 208 of the vessel 204. It is contemplated that other positions and orientations of the anti-corrosion apparatus 202 within the vessel 204 fall within the scope of the disclosure, provided that such other positions and orientations allow the anti-corrosion apparatus 202 to be in at least partial fluid communication with the aqueous solution 206. The anti-corrosion agent 205 may include any of various corrosion inhibiting compounds. In one embodiment, the anti-corrosion agent is in solid powdered form. In another embodiment, the anti-corrosion agent is a liquid.

FIG. 3 is schematic block diagram illustrating one embodiment of a method 300 for making a block of anti-corrosion substance. The method begins 302 by selecting 304 an anti-corrosion agent. The anti-corrosion agent may be a single type of anti-corrosion compound or it may be a combination of multiple types of anti-corrosion compounds. For example, an aqueous solution may include various corrosion factors such as multiple surfactants, multiple types of removed oil/stains/debris, and the vessel containing the aqueous solution may be constructed of various types of materials (ceramic, steel, aluminum, copper, plastic, etc.). Accordingly, multiple anti-corrosion agents may be selected 304 to counter each corrosion factor present in a certain application. For example, BRITESIL H2O (produced by PQ Corporation) may be selected 304 as the anti-corrosion agent because of its ability to inhibit corrosion caused by alkaline cleaners. Other characteristics of the aqueous solution that may affect the selection 304 of an anti-corrosion agent include the concentration, pH, temperature, pressure, viscosity, solids content, volatiles content, and flow rate.

The method 300 also includes selecting 306 a carrier material for the anti-corrosion block. As discussed above, the carrier material principally functions as the solubility modifier of the anti-corrosion agent. As identified above, one of the noteworthy shortcomings of conventional cleaning systems is the rapid dissolution of anti-corrosion compounds in aqueous solutions. A user must either continually add anti-corrosion compounds to an aqueous solution or must repeatedly add anti-corrosion compounds if the cleaning is performed in batch operations. Therefore, selecting 306 a carrier material may involve determining the proper solubility for a particular application in order to achieve restrictive or controlled dispersion of the anti-corrosion agent. In one embodiment, a single organic or inorganic compound may be selected 306 as the carrier material. In another embodiment, the carrier material may include multiple organic or inorganic compounds, thereby allowing the user greater control over the solubility of the anti-corrosion substance. It is contemplated that in one embodiment, the water solubility of the anti-corrosion substance is in the range of between about 5 grams per liter and 1,000 grams per liter. In another embodiment, the water solubility of the anti-corrosion substance is in the range of between about 10 grams per liter and 500 grams per liter. In yet another embodiment, the water solubility of the anti-corrosion substance is about 100 grams per liter.

For example, in one embodiment in which the aqueous solution contains high concentrations of corrosion promoting surfactants, a carrier substance with a relatively high solubility may be selected in order to disperse more anti-corrosion agent into the aqueous solution. However, if the solubility of the carrier substance is too high, the aqueous solution may dissolve the carrier material too quickly and cause an excess of anti-corrosion agent to be dispersed, which can be wasteful and inefficient. Accordingly, the carrier material is selected 306 to dissolve sufficient anti-corrosion agent in order to both adequately inhibit corrosion and prevent excessive waste of the anti-corrosion agent due to oversaturation. In another embodiment, instead of a single carrier material, multiple materials may be selected 306 as the carrier material. With embodiments having multiple carrier materials, the user has greater control of the solubility of the final anti-corrosion block because the solubility of the block is not limited to the solubility of a single carrier material, but the working average of multiple carrier materials. Therefore, upon mixing two or more carrier materials together, the resulting compound will have an effective working solubility somewhat between the solubility of the independent carrier materials. In this manner, the solubility of the block can be precisely selected 306 according to the characteristics of a particular application.

Another factor that may be considered in selecting 306 a carrier substance is the melting point. As discussed in the next step of the method 300, in some embodiments the carrier substance is melted before mixing the anti-corrosion agent with the carrier substance. In one embodiment, a carrier substance is selected 306 with a melting point in the range of between about 50° C. and 200° C. By choosing a carrier substance with a melting point below 200° C., the current method 300 will not require excessively high temperatures, therefore reducing the amount of heat and energy required for the process. Additionally, by selecting 306 a carrier substance with a melting point above 100° C., the user avoids any complications that may arise if the aqueous solution into which the anti-corrosion substance were to be used was at a temperature high enough to melt the anti-corrosion substance. Other than the potential issue of melting the carrier substance in the aqueous solution, the anti-corrosion substance is substantially temperature independent. However, the selection of a carrier substance based on its melting point is a matter of manufacturing convenience and therefore is not intended to limit the scope of the present disclosure.

The method further includes combining 308 the selected anti-corrosion agent with the selected carrier material. In one embodiment, the combining 308 is performed by raising the temperature of an organic acid up to or slightly above its melting point, which causes the solid organic acid to melt and form a molten organic acid medium. Once molten, the carrier substance can be combined and uniformly mixed with a powdered anti-corrosion agent. In another embodiment, an organic or inorganic solid is selected 306 as the carrier substance and the carrier substance and the powdered anti-corrosion agent are combined 308 through compression fusing the two solids together. In yet another embodiment, combining the anti-corrosion agent and carrier material may be performed by evaporative deposition of an anti-corrosion agent onto the surface of the carrier substance. In one embodiment, the mass ratio of anti-corrosion agent to carrier material is in the range of between about 1:1 and 1:100. In another embodiment, the mass ratio of anti-corrosion agent to carrier material is in the range of between about 1:5 and 1:20. In yet another embodiment, the mass ratio of anti-corrosion agent to carrier material is about 1:10. It is contemplated that other techniques recognized by those of ordinary level of skill in the art can be used to combine 308 the anti-corrosion agent with the carrier substance without departing from the essence of the present disclosure.

Additionally, the method 300 includes forming 310 the combination of the anti-corrosion agent and carrier material into a block of anti-corrosion substance. In one embodiment, the anti-corrosion block is formed 310 by pouring a mixture of a molten organic acid medium and anti-corrosion agent into a mold and allowing the mold to cool. The size and shape of the molds may be selected according to the requirements of the application to produce an anti-corrosion block having a requisite size and shape. For example, a certain waste tank in a cleaning application may require cylindrical-shaped anti-corrosion blocks with a specific diameter and length (e.g., about 3 inches in diameter and 0.5 inches in length). In another embodiment, the anti-corrosion block is formed 310 by compression fusing an organic or inorganic solid carrier substance and a anti-corrosion agent into a block. After forming 310 the anti-corrosion block, the method 300 ends 312. The following experiments were conducted by substantially following the steps of the method 300.

### Experiment 1

In one embodiment, 100 grams of BRITESIL H2O (PQ Corporation) were selected as the anti-corrosion agent and 900 grams of sodium carbonate were selected as the carrier material, the sodium carbonate having a water solubility of 216 grams per liter. The sodium carbonate was mixed together with the BRITESIL H2O and then pressed into two inch diameter tablets.

### Experiment 2

In another embodiment, 100 grams of BRITESIL H2O (PQ Corporation) were selected as the anti-corrosion agent and 900 grams of magnesium sulfate were selected as the carrier material, the magnesium sulfate having a water solubility of 71 grams per liter. The magnesium sulfate was mixed together with the BRITESIL H2O and then pressed into two inch diameter tablets.

FIG. 4 is a schematic block diagram illustrating one embodiment of a method 400 of using an anti-corrosion substance to inhibit corrosion of a vessel containing an aqueous solution. The method 400 begins 402 by placing 404 an anti-corrosion substance into a container. In one embodiment, the container already has an aqueous solution which is capable of promoting corrosion. In another embodiment, the aqueous solution is suctioned or pumped into the container after the block of anti-corrosion substance has been added to the container. The method 400 includes ensuring 406 that the anti-corrosion substance is in at least partial fluid communication with the aqueous solution. As described above with reference to FIG. 1, the anti-corrosion substance may be oriented in any of several different positions within the container. The method 400 further includes allowing 408 the anti-corrosion substance to slowly dissolve into the aqueous solution and inhibit corrosion, after which the method 400 ends 410.

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment.

Furthermore, the described features, structures, or characteristics of the disclosure may be combined in any suitable manner in one or more embodiments. In the following description, numerous specific details are provided to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the disclosure.

The schematic flow chart diagram included herein is generally set forth as a logical flow chart diagram. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

The present disclosure may be embodied in other specific forms without departing from its spirit or essential characteristics. The described embodiments are to be considered in all respects only as illustrative and not restrictive. The scope of the disclosure is, therefore, indicated by the appended claims rather than by the foregoing description. All changes which come within the meaning and range of equivalency of the claims are to be embraced within their scope.

What is claimed is:

1. An anti-corrosion substance comprising:
an anti-corrosion agent; and
a carrier material intermixed with the anti-corrosion agent, the carrier material being at least minimally soluble in an aqueous solution.

2. The anti-corrosion substance of claim 1, wherein the carrier material comprises at least one type of inorganic solid.

3. The anti-corrosion substance of claim 1, wherein the anti-corrosion agent comprises at least one type of silicate-based anti-corrosion compound.

4. The anti-corrosion substance of claim 1, wherein the anti-corrosion substance comprises a solid block of intermixed anti-corrosion agent and carrier material.

5. The anti-corrosion substance of claim 1, wherein the mass ratio of anti-corrosion agent to carrier material is between about 1:100 and about 1:1.

6. The anti-corrosion substance of claim 1, wherein the mass ratio of anti-corrosion agent to carrier material is between about 1:20 and about 1:5.

7. The anti-corrosion substance of claim 1, wherein the mass ratio of anti-corrosion agent to carrier material is about 1:10.

8. The anti-corrosion substance of claim 1, wherein the anti-corrosion substance has a water solubility in the range of between about 5 grams per liter and about 1,000 grams per liter.

9. The anti-corrosion substance of claim 1, wherein the anti-corrosion substance has a water solubility in the range of between about 10 grams per liter and about 500 grams per liter.

10. The anti-corrosion substance of claim 1, wherein the anti-corrosion substance has a water solubility of about 100 grams per liter.

11. A method for making an anti-corrosion substance, comprising:
selecting an anti-corrosion agent capable of inhibiting the corrosion of a vessel containing an aqueous solution;
selecting a carrier material that is at least minimally soluble in the aqueous solution;
combining the anti-corrosion agent with the carrier material; and
forming the combined anti-corrosion agent and carrier material into a solid anti-corrosion substance.

12. The method of claim 10, wherein combining the anti-corrosion agent with the carrier material comprises melting the carrier material.

13. The method of claim 11, wherein combining the anti-corrosion agent with the carrier material comprises mixing the anti-corrosion agent with the melted carrier material.

14. The method of claim 10, wherein combining the anti-corrosion agent with the carrier material comprises compression fusing the anti-corrosion agent together with the carrier material.

15. An anti-corrosion system, comprising:
an anti-corrosion agent; and
a carrier, within which the anti-corrosion agent is contained, the carrier providing at least a partial barrier between the anti-corrosion agent and an aqueous solution, the carrier also comprising a means for controllably exuding the anti-corrosion agent into the aqueous solution.

16. The anti-corrosion system of claim 15, further comprising a vessel containing the aqueous solution, the aqueous solution in fluid communication with the carrier.

17. The anti-corrosion system of claim 16, wherein the carrier is attached to an inner wall of the vessel.

18. The anti-corrosion system of claim 16, wherein the carrier is floating in the aqueous solution.

19. The anti-corrosion system of claim 16, wherein the vessel comprises an inlet and an outlet, and wherein the carrier is attached to an inner wall of the inlet of the vessel.

20. The anti-corrosion system of claim 15, wherein the anti-corrosion agent and carrier form a solid block.
